(19) United States
(12) Patent Application Publication
(10) Pub. No.: US 2005/0080804 A1
(43) Pub. Date: Apr. 14, 2005

(54) System and method for maintaining componentized content

(76) Inventors: Robert David Bradshaw JR., San Jose, CA (US); Kevin Vincent Cochrane, San Francisco, CA (US); Jack Shilian Jia, Los Altos Hills, CA (US); Britt Park, Scotts valley, CA (US); Meili Zhong, San Jose, CA (US)

Correspondence Address: GLENN PATENT GROUP, 3475 EDISON WAY, SUITE L, MENLO PARK, CA, 94025, US

(21) Appl. No.: 10/504,004

(22) PCT Filed: Feb. 10, 2003
(86) PCT No.: PCT/US03/03952

Related U.S. Application Data
(60) Provisional application No. 60/335,261, filed on Oct. 30, 2001.

(51) Int. Cl. G06F 17/00

(52) U.S. Cl. 707/102

(57) ABSTRACT

A system and method is provided for creating component to save storage space, and to efficiently organize and maintain content. In one embodiment, a system is provided that is configured to manage the componentization (802) of content within entities that share common content. The system includes a content control (118) module configured to manage the editing (236) of content and their state such as whether and when they were modified (606) or mutated (610). Alternatively, the system may include a repository (700) configured to manage the indexing (702) and searching of component (704).

### BACKGROUND

The invention generally relates to document repository systems and, more particularly, to systems and methods for storing and maintaining documents.

Applications specifically tailored to developing and maintaining Internet websites are well known in the website development industry. Many of these applications offer simplified methods for designing and maintaining a website. These methods may include facilitating the receiving, storing and arranging of and the delivering of web content and related information to a server used to host websites. In more advanced systems, information must be stored in multiple locations and in different files so that other advanced functions of the application program and related systems can operate and have access to certain information. Document retention and control is thus difficult to manage.

Due to the need to coordinate the efforts of many development contributors, it is a challenge to develop and organize documents and their contents. Furthermore, many documents need to be frequently modified, which is usually done by numerous contributors that typically modify them in an ad hoc process. Problems occur when users from separate workstations try to update the same information in a document, confusing the process. Propounding the problem, many businesses that depend on the development and maintenance of such documents require updates by the day, hour or minute, and by numerous contributors. And, as the number of contributors increases, so does the volume, and complexity of content, as well as its use. As information is created, it must be saved by all of these contributors, who may or may not be diligent in maintaining proper data preservation procedures. As a result, managing document files for efficiency and quality control has become difficult.

In response to these problems, system applications have been developed for managing website development. Some of these include software configuration management systems, document management systems and database publishing systems In one such application, documents used to develop and maintain websites may be worked on within work areas where individual website developers construct or maintain separate portions of content. This helps to spread out the tasks of website development to multiple people. The final contributions from each developer may then be incorporated, combined into an integrated document or documents, and then deployed to a production server that uses the documents in hosting a website.

There are several disadvantages associated with such systems. For example, where maintaining such documents may require the efforts of large numbers of people, it may be desirable to have the various content contributors work in parallel. Software configuration management systems do not allow contributors to simultaneously make changes to the same content. And, conventional systems typically do not allow individual contributors to separately test their own work without deploying and publishing it to the website. The result is that individual contributors cannot foresee the effects of their contributions when combined with, other contributions. Also, deployment of the website content is often done with little control over the deployment process itself. As a result, conflicting changes may be posted to a website, corrupting its content and undermining the website's integrity.

Compounding the problem, most development systems involve multiple documents for deployment to production servers for use in maintaining websites. These documents must be maintained individually, including all content contained in the document. Many types of conventional document storage and maintenance systems exist for such applications, but all are cumbersome, requiring modification of every document individually. In such systems, documents are stored in storage systems according to document information such as tags or metadata. Content within each document must be modified or otherwise maintained individually to change content contained within it. Thus, any text, graphics or other content located in a document must be updated on a document by document basis, making it difficult to maintain consistency.

In many applications, however, common content may reside in multiple documents. For example, content pertaining to universal information such as copyright information, legal disclaimers, trademark logos and other information exist in multiple webpages. These documents may be consistently and universally maintained. For deployment of these documents for use in website maintenance and development, this means that changes to any universal content must be maintained on a page by page, thus document by document basis.

It would be useful, therefore, to develop a system or method for modifying such universal content in an efficient manner. As will be seen, the invention accomplishes this in an elegant manner.

### BRIEF DESCRIPTION OF THE DRAWINGS

FIG. 1 illustrates a computer network system for website development in accordance with the invention;

FIG. 2 illustrates a more detailed view of a document content control application of FIG. 1 in accordance with the invention;

FIG. 3 illustrates an example of a componentized document in accordance with the invention;

FIG. 4 is a flow diagram illustrating a rendering process in accordance with the invention;

FIG. 5 is a flow diagram illustrating an encoding process in accordance with the invention;

FIG. 6 is a flow diagram illustrating a submission and deployment process in accordance with the invention.

FIG. 7 illustrates a component repository in accordance with the invention;

FIG. 8 is a flow diagram illustrating an indexing process in accordance with the invention;

FIG. 9 is a flow diagram illustrating a searching process in accordance with the invention.

### DESCRIPTION OF THE INVENTION

The invention provides a system and method for creating and maintaining content components. In one embodiment, a system is provided that is configured to manage the componentization of content within entities that share common content. The system includes a content control module configured to manage content for use by a system. The system further includes an editing application configured to manage the editing of content, and a component control module configured to manage components as well as their states, such as whether and when they were modified or mutated, as discussed in more detail below. Alternatively, the system may include a repository configured to manage the indexing and searching of components. The repository has an index module configured to manage the indexing of components according to tags associated with individual components and a version module configured to indicate the state and version of a component. The repository further includes a query module configured to manage searching of components, the query module having query rules configured to set parameters for searching components.

The system may be configured to componentize content and to develop documents composed of a document skeleton having content and tags that identify componentized content to be incorporated into the document upon rendering. If the system is configured to componentize website content, the system further includes a development server configured to develop documents having website content, wherein a document is composed of a document skeleton having content and tags that identify componentized content to be incorporated into the document upon rendering.

Embodiments of the invention are illustrated and described in the context of a website maintenance and management application, where documents are componentized for shared use within the application for creating and maintaining web content. It will be understood by those skilled in the art though, that this is merely one embodiment of the invention, and that the invention is not limited to such a narrow application. The invention, on the other hand, has far greater scope, as is defined in the claims.

Embodiments of the invention are further described in the context of electronic documents. Documents have a formal definition in specific languages, such as XML language. The invention, however, is not limited to documents in the sense of XML, document management or other narrow concepts. Rather, the invention extends to any entity that encompasses relevant data that may include text, images, video and other forms of expression that are relevant to an application. For example, an online learning course may be defined as a document, and each of its lessons as components. As another example, a company may produce a product catalog, where the catalog itself is document, and each product or groups of products may be components and subcomponents of the document. Those skilled in the art will understand that an entity described as a document is generic for purposes of this description of the invention, and it in no way limits the spirit and scope of the invention, which is defined by the claims below.

These documents may be deployed to production servers to define website pages for website development and maintenance. However, it is contemplated that the invention has much broader application where the componentization of documents for various applications is useful. The components can be identified and isolated according to particular componentization rules that govern the maintenance of the content. Such rules may include placement parameters for locating the components, versioning rules for maintaining versions of components, and access rules for governing access to the components.

Those skilled in the art will understand a component to be part of a larger whole with respect to documents. According to the invention, components are configured so as to enable the reuse of components in possibly multiple documents. Those skilled in the art will also understand that the general concept of rendering relates to composing something out of smaller parts. In the context of the invention, rendering relates to the process of replacing component references located within a document with component contents. In such a configuration, documents are configured to contain references to components that contain content that is shared with other documents that have the same references. Also, the invention provides the ability to share components with other documents. In one embodiment, there is one single copy of the component, which may be modified by a user with the proper privileges. This saves on storage space, as componentized content can be stored in a single location, but applicable in multiple locations. Thus, the component would be referenced in a skeleton document, which may contain document-specific contents, as well as references to components. When the document is rendered, the document skeleton is retrieved, and the componentized content is incorporated into the skeleton document. This rendering, where the document is assembled, allows a system to store the individual document entities separately, saving space by storing the reusable components only once.

Also, if a component is updated, then every document that references the component is automatically updated via the component. Thus, each document containing the component would not need to be separately updated, unlike conventional applications, which would need to be updated manually.

In a computer system that manages a quantity of data, the data is stored in computer memory in the form of documents or files. For example, in a system for maintaining and making changes to content for a website, extranet site or intranet site, physical memory may be allocated for work areas, staging areas and edition areas. In one example of a web development and maintenance system, work areas may store in-progress changes to be made to the content by an individual contributor or group of contributors. The storage may be a backing store containing a file being developed or maintained in a work area along with processing instructions. Unlike conventional systems, this example may be configured to automatically retrieve, deploy and store content that culminates from these in-progress changes in a manner that may or may not be transparent to users maintaining and developing content. According to the invention, documents stored in memory can contain components that contain content of universal application and use in multiple documents located within the system. These components may be incorporated into multiple documents when they are rendered or otherwise accessed.

One purpose of components is to provide consistent content of universal application or use when used within documents. They must therefore be centrally controlled by users or entities having exclusive or limited shared access to the components. This distinguishes the content from other skeleton content that can be accessed by users in work areas where general website content is developed and maintained. Thus, the content within the components may have different access rights and properties than other content. They may also be the same. It is possible for a document owner, one who has privileges to modify the contents of the document, to also be an owner of the component. In other embodiments, it is also possible to have privileges associated with the documents that are different than privileges associated with the components. For example, it would make sense in certain applications for a central authority to control the contents of components that are universally applied. If pricing information were composed in a component, it could be centrally controlled so as to ensure uniformity in price figures, and to allow instantaneous changes from a single component modification.

These components may be distinguished from other content in a document according to particular properties. One way is the manner in which the componentized content appears in contrast to other content, such as the skeleton content, when rendered. This is useful to apply in the visual display of the document when being viewed. For example, when a document is rendered by a user in a work area, a visual representation of the document appears on a user's monitor. The representation of the content may include textual information as well as graphics. This information may be displayed according to a template format to preserve uniformity in the final product. The componentized content may appear different than other content, indicating that the content may be inaccessible. The system displaying the componentized content may also simply not accept changes by a user if attempted.

Once the changes are made in the work areas, the changed content may be submitted to a staging area or areas. In the staging area, the content changes may be combined. From the staging area, the changed content may be forwarded to an edition area or areas. The edition areas may store versions or editions of the content for the website, extranet site or intranet site. The data may then be deployed to devices or systems that may utilize such content. In one embodiment of the invention, if componentized content is incorporated in the submitted content, only components that have been modified need to be submitted.

In one embodiment, a mutated document is one where the components are modified, but the remainder of the document remains the same, and a modified document is one where the skeleton of the document, or the non-componentized contents, are modified. In the event of a change of a component, the universal application of the component would necessarily cause various documents to change by virtue of their incorporation of the modified component. A document that only has changes in its componentized content is deemed a mutated document. Such a document would not necessarily need to be submitted to staging and edition areas. Files that are merely mutated need not necessarily be submitted. Thus, if a document is changed, but the components that it contains are not changed, the components need not be submitted with the document. The original, unmodified components will be used automatically. This can extend to files having sub-components as well.

As an example of a file that is modified versus one that is mutated, suppose document X contains components A & B, and supposed component B in turn contains sub-components C & D. If you modify D, then X & B are mutated while A & C are completely unchanged. Since D is the only file that has actually been modified, it is the only file that needs to be submitted to the staging area. However, in a preferred embodiment, when it comes time to deploy this content to an external web server (etc.) then mutated files would also need to be deployed in addition to the modified ones. In that case, X, B & D need to be deployed, even though D was the only file that was modified.

In a deployment scenario, criteria must be established for transmitting work area content to a website production server or other entity hosting the website. As a general rule, only modified files are submitted to a staging area. And, changes may eventually be submitted to an edition area before they are eventually published. However, according to the invention, in a preferred embodiment, componentized content is not modified in the usual work areas, and is treated differently. The componentized content is usually modified by a privileged user who has the authority to make the changes. The authority to modify the components may be granted and shared according to a particular application. These changes are subsequently incorporated into documents that have the respective components incorporated in the document content. Thus, any changes to components have universal application.

Components may also be deployed separately from any documents that incorporate them. They may not submitted by a work area in the normal process of website development. Therefore, they need not be deployed in the same manner. In a preferred embodiment of a website maintenance application, all files should be deployed from a staging or edition area. Because of their shared nature, components may go through different approval processes, but they would still be subject to staging and edition processes, where it is referenced in a document, and incorporated in a document upon rendering. In one embodiment, a modified skeleton of a document, the document parts that are not componentized, may be submitted to a staging and edition area without submitting the components if the components are not themselves modified. In this case, the components would not need to be submitted to the staging or edition areas at the same time as the document skeletons, because they would likely be submitted already.

In a preferred embodiment, the only part of a document that actually gets stored in the staging or edition areas is the document skeleton and only references to the components contained within it, not the component contents themselves. In this embodiment, a mutated document, one in which only the components were modified, does not need to be submitted to staging, because the document skeleton itself is unchanged. Hence, copying the document to staging is pointless because the document skeleton of the mutated document is identical to the one already stored in the staging area.

This is because components may be identified in a document by a tag or other identifier, allowing a system to incorporate the changes by simply replacing those tags or identifiers with the current contents of the components that they refer to, and not needing to collaborate with other users or entities submitting content. This is in contrast to a document that has undergone modification to its content in a work area, where such a document is deemed modified, and must be combined with other submitted content. Also, in deploying mutated documents, only the components would need to be deployed to a production server. The components can then be updated for use in documents located elsewhere. In another embodiment, the components may be replaced with new components, rather than changing the tags or identifiers.

In another embodiment, if the implementation were changed so that fully rendered documents, rather than just the document skeletons, were stored in the staging or edition areas, then there would be no concept of mutation, and making a change to a component would require modifying the contents of each document that contains it. And since the bytes contained in the document are actually changed in this case, each document would be formally modified and so need to be submitted anew to the staging area.

Again regarding the deployment of documents, the development system may deploy documents that have been modified according to timestamps of modification. The system can keep versions of content that has been modified at different times, and can deploy new and old versions of content for production on a server hosting the website according to the appropriate timestamp. According to the invention, a document may now have two timestamps, one indicating when the document was once modified, and another indicating when it was last mutated. Thus, when a document defining content being hosted by in a website has been modified in a work area, its timestamp is updated, and it is submitted to a staging area. Versions of the document still exist, and can be reverted to according to the needs of the development server. For example, if an airline mistakenly released a reduced fare on a website, it may want to revert back to an earlier version of the document according to its timestamps to place the old fare back on its website. Similarly, mutation times may be indicated by a separate timestamp so that a development system can keep track of whether mutated documents are properly updated on a production server. Once a document has been processed in staging and edition areas, it may be deployed to a production server to update the web page or pages. In another example, a component may contain a modified fare. In this case, a component may be submitted to a staging area. As a result, the document that contains the modified component would be mutated. In this case, the document would need to be redeployed to the production server.

Depending on the modification and mutation status of a document, it may be deployed in different manners. Deployment of modified documents in a website development application would necessarily require the document to be submitted to a staging area and a subsequent edition area. Since the nature of the application is to collaborate content for use in the production of a website, these processes can be crucial to the process. In contrast, according to the invention, the deployment of mutated documents, documents that include modified components, do not need to be processed through the same system. One benefit of componentizing documents is to sidestep the publication process to some degree, and to produce and deploy components for universal application in multiple documents. Upon deployment, in one embodiment of the invention, a system can deploy a modified or mutated document to update a production server. Alternatively, components can be deployed separately for insertion into documents in which they are incorporated.

In one embodiment, the development server contains the document content control (discussed below) that is configured to enable and control the use of components and other content. The development server would serve to transmit fully rendered versions of documents to a production server. As such, rendering would occur at the time a file is deployed from a staging area of the development server to a production server. The concept of mutation allows the system to know when components are have been modified, hence, mutating the document. Once this is determined, in the event a file becomes mutated, as opposed to modified, files can be deployed to a production server even though any files have not themselves been modified. For example, if a change is made to a component, containing a promotional airline fare for example, that is used in ten documents; one component may be submitted to the staging area. This would cause ten documents that contain the component to appear mutated, signaling that the documents need to be deployed to the production server. This may take the form of the airline fare being deployed to several production servers in different geographical locations hosting websites to display the fare. Thus, in response to a user's change, which is the component, ten documents may be automatically updated and identified for deployment to a production server.

According to the invention, a website development system can greatly benefit from components in the manner in which a document is rendered. When a document is stored in a file that resides in a file system, any components may be stripped away and replaced with a tag that identifies the component, along with its location in the document and other property information. Then, when the document is retrieved from its location in the system and rendered, the components can be pulled in to the document. This can occur transparently from any user. For example, a user pulling up a document from a file would render the document in the user's particular operating system. The document would appear with its all of its content, including content that can be modified in the work area, as well as components, which can not. Similarly, a production server may retrieve a document from memory and render it for website hosting. The document would be rendered and appear on a hosted website including all of the document's content and components.

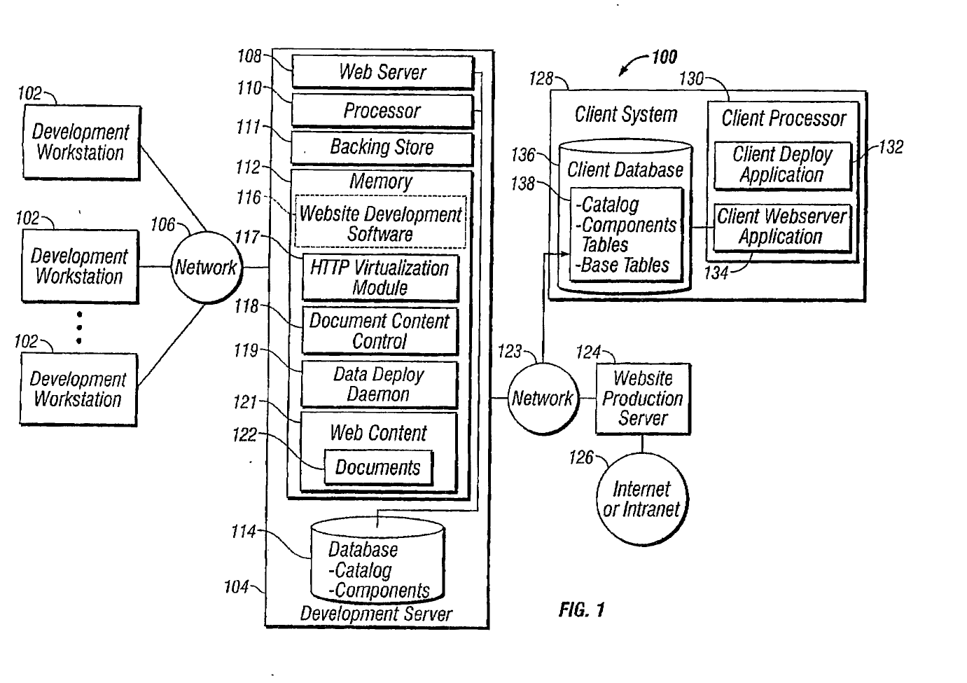

Referring to FIG. 1, a block diagram of such an application is shown incorporated in a system for website development and maintenance. The website is maintained by users occupying workstations 102. The users develop particular areas for use within the website in individual work areas, which are stored separately from other areas. Once a user working within a work area has completed a task for the website, the user may submit the content to a staging area for review. The staging area is configured to hold information pertaining to areas within the website from the multiple work areas. The proposed changes to the website can be displayed at the staging area for review before they are published in the final website. Once the changes are approved at the staging area, the changes may be published by deploying the web content and the website is modified.

In order to perform the development of content according to this functionality, the proper deployment of different types of data must be achieved. The concept of deployment includes the transfer of different types of data in particular ways to particular locations, perhaps multiple locations. File data, such as web content, may be transferred to a target file system, such as a production server where the web content is displayed to web browsers. Metadata and template data, which relate to the web content or other file data, may be deployed to certain databases where they are utilized.

In order to store particular information properly, a user utilizing conventional methods typically must compile the changes created in a work area into a file and store the file in the database Taking into account the voluminous and varied information produced in a work area, this can be an arduous task, requiring considerable time to execute. Of course, this takes precious time away from the task of producing and maintaining a website. Componentizing documents can save enormous amounts of time in developing and maintaining website content. This is accomplished by establishing components that have universal application in multiple documents.

In order to understand one embodiment of the invention related to deploying scripts in website development and maintenance solutions, it is useful to understand an example of such a solution. FIG. 1 illustrates an example of such a system. Referring again to FIG. 1, in one or more development workstations 102, website developers may add, remove, edit and examine files for a website. Development workstations may include conventional personal computers, UNIX workstations, or other workstations that can be configured to develop content. The development workstations 102 may be connected to a development server 104 via a computer network 106, such as the Internet or LAN.

The development server 104 may include a web server 108 for serving up content to web browsers, and a backing storage 111 for storing versions of website content. The server 108 processes HTTP requests from the development stations 102 for website content (e.g., files). The website files may be physically stored in the backing store 110 which may be conventional, such as the WINDOWS NT filing system commercially available from Microsoft Corporation. The backing store may serve as a central location to store all data that is created, transferred, or otherwise maintained within the system. The storage of data may be executed transparent to the user.

The development server 104 may also include a conventional memory 112 (e.g., RAM) where the processor 110 implements the website development methods of the invention by executing software code 116 stored in the memory 112. An HTTP protocol virtualization module 117 may be executed by the processor 110, allowing the development server 104 to operate as if it were multiple servers. Document content control 118, described in more detail below includes code to control and enable the development and editing of content according to the invention.

Deploy daemon 119 may be included in development server 104 to enable the government and monitoring of the deployment from the development server's point of view. Such an application may include scripts that may be executed on the development server. It may also include commands that may be sent to other devices or entities associated with the deployment of data to execute scripts. Custom systems may be written to generate other files or configuration files to be used by the production server.

The development server 104 may be coupled to a website production web server 124 via a network 123. Network 123 may be the same network as network 106 or a different network, such as a LAN. The web server 120 may also be coupled to the Internet or an intranet 126. When a website is ready to be posted on the World Wide Web or on an intranet, the development server 104 sends the website content to the production web server 124 which then provides Internet or intranet access to the website, depending on the system configuration. Network 123 may deploy data to client database 136 that originated in development server 104.

The system may include client system 128, which may be located at a remote site and connected to the network. The client system may include client processor 130 may be a personal computer or server located at a client location where websites are maintained and hosted. The processor may be connected or otherwise communicate with other computers or devices via a network, such as a LAN, wireless, or other network. The processor may include a client deploy application 132 stored in memory and configured to deploy data in order to enable the client system to control the website production server 124. Client webserver application 134 is configured to access the client database and to provide the client processor with data, including a database catalog, components, delta tables, base tables and other content.

Data deploy daemon 119 may also be configured to enable the deployment of metadata and templated data to client database 136. In this example, templates and metadata may be transferred to client systems as database content where delta tables and base tables are maintained. The templated data may include components developed in development server 104. These templates and metadata may then be used by the client in maintaining its website.

Client system 128 may include database content 138 that includes delta tables, base tables, catalogs and component content used in developing and maintaining websites. In one embodiment of the invention, the componentization process occurs in the client system similar in nature to the manner in which it is employed in the production server. In another embodiment, the componentization process occurs in the production server, where components are incorporated into documents as they are published with other website content. The invention is not limited to a particular location for componentization to occur. Embodiments may vary according to applications.

A base table may be established in client database 136. The base table may be a snapshot of a staging area located within development server 104. These base tables may be updated as the staging area changes via further data deployments. The client system 128 may include database services client webserver application 134, configured to allow a client to make changes to a website. This allows a client to maintain its own website or other application that the development server services. In this respect, delta tables may be established in database 136 to preserve changes that users may make in client system 128. In one respect, the delta tables and base tables operate along with the client application similar to the function of the development workstations 102 that send changes to staging areas. In this respect, the client application may act as the workstation. The changes in delta and base tables emulate the corresponding content in work areas and a staging area. The benefit to this configuration is that maintenance of a website may be under the control of the development server, or may be separately under the control of the client application in conjunction with the client database.

The client system may also include client processor 130 for controlling the inter-workings of the client system, such as receiving and deploying content and related information, including components for display on a website. Client processor 130 may include client deploy application 141, that may be configured to interact with deploy daemon 119, a deploy application located in the development server. Together, the deploy applications can enable the development sever and the client system to monitor and control the deployment process. The computer may be configured to maintain websites served from a client location. The client computer includes a CPU for controlling the inter-workings of the computer and a modem connected to a network 123 for sending information to other destinations. The client computer may further include a cache for storing frequently used data. Memory, controlled by the CPU, can be a conventional memory and can be a random access memory (RAM), a dynamic random access memory (DRAM), a static random access memory (SRAM), or any other memory configured to store and transfer digital data therefrom. The memory may include one or more work areas that may be defined as a collection of directories located on the development server, thus, not a separate computer in and of itself. Thus a work area may be defined merely as a set of files that a user at a client or development computer has authority to access.

If on a separate computer, it will be apparent that the client processor is conventional and that various modifications may be made to it. Data can be stored in the database, or may optionally be stored in data files, which gives a user an organized way to store data. The client processor may also include a conventional operating system, such as Windows, for receiving content from the development server to further develop and maintain.

A website is generally comprised of the contents of an arbitrary file system. The website development system 100 of the present invention may include hierarchical file systems. Each such file system of the present invention provides an environment for managing and manipulating individual files. When executed, the website development software 116 enables the management and manipulation of files. The backing storage 110 is where the files and corresponding metadata may be physically stored. Metadata is generally data that is related to work content. Some examples include for example content owner identification, group identification, access control, file name, modification times, creation times, extended attributes (EAs), website addresses associated with the content, and other information related to the content.

A hierarchical file system of the present invention may be referred to in the art as an “area.” There may be different types of areas including work areas, staging areas and edition areas. A work area may be a modifiable file system that is used by persons who create and maintain web content in work files for eventual use in a website. A staging area may be an area where content from these work files is assembled before it is published. A central control person, such as a webmaster, may review content submitted from work areas within a staging area or an edition area. Since the work areas are generally areas for creating and maintaining content exclusively, the staging and edition areas may be restricted to only assembling and displaying content. By design then, they may be configured as read-only file systems. Any modifications to content may then possibly need to be sent from an editor back to a workstation to perform any changes that may be needed. This helps to maintain the integrity of the content and to simplify the process. However, a business may want the system 100 to be more flexible, allowing other people such as editors to modify the content before it is published. The automatic storage and possibly modification of data upon the occurrence of certain events may be desired in order to preserve data produced or otherwise modified during development or maintenance of a website. This way, different versions of content may be preserved and time-stamped, allowing developers and possible editors and administrators the ability to revert back to different versions of the content.

In one embodiment of the invention, components and subcomponents may also have time stamps to indicate when they are modified. As the components are universally integrated, they can be updated according to their creation and modification time. In a preferred embodiment, timestamps for components are maintained for both a modification time and a mutation time. This is because a component can contain sub-components. It is also possible for components to be mutated in the same way as documents, i.e. its skeleton content is unmodified but one or more of its subcomponents are modified or mutated. The mutation time of either a component or document may be computed by examining the mutation and modification times of all of its subcomponents and then choosing the most recent one. Since documents and components can contain subcomponents, some deeply nested, this is a recursive process. In order to find the mutation time of a document, the system needs to know the mutation time of each of its components. And, to find the mutation time of a component, it needs to know the mutation time of its subcomponents, and so on.

Since components are changing, the mutation times of documents or components may change even though the document or component itself, or actually their skeleton content, has not been modified. In theory, this mutation time would need to be recomputed for a document or component every time a user requests the component or document. This is a potentially slow process. However, many software applications assume that gathering attribute information about files, such as timestamps, is a relatively fast operation. Therefore, such applications may ask the system for the timestamps repeatedly, rather than go to the trouble of asking for them once and keeping a copy of the result locally for subsequent reuse. Therefore, because that usage pattern for timestamps is so common, the system can cache the results of a potentially slow mutation time computation so that programs that ask repeatedly for attributes will not suffer degraded performance.

Component, subcomponent or other document content may be submitted from a work area to a staging area for review. Upon the occurrence of the submission of data, metadata associated with such content may be modified in order to distinguish the changes made from the original version. This way, different versions may be preserved and organized. To save space, only the deltas, or actual changes, may be stored from each version. This can be useful in the day-to-day operations of a website. For example, an airline may advertise different fares online, to which purchasers may order tickets for flights. An error in publishing a fare may occur, such as a fare that is much lower than planned, giving purchasers a windfall. A website administrator may then revert back to the earlier website, and avoid losing money by selling too many low fares. Having older versions of content, therefore, may be crucial to certain businesses.

In addition, the application may be configured to keep metadata and template data changes in delta tables, which emulate the corresponding content in a staging area. Tracking table (not shown) tracks the different changes proposed for the website as it is modified in response to changes proposed by each client work area and may be accepted by an authority of the client. The tracking table is configured to track the various tables created, such as base tables, and also tracks the interrelationship among the various tables. The tracking table may keep track of the characteristics of the different tables such as the times and dates in which they are created, the interrelationships of the tables such as which base tables correspond with different delta tables, and other characteristics. In such a configuration, data may be deployed from a development server to a webserver.

One embodiment of the invention is directed to the ability to control and monitor the development, maintenance and deployment of componentized content data throughout the system. According to the invention, the componentized content may in some respects be treated differently in the publication process discussed above regarding content modified in a work area. This is because centralized modification and control is required of components. Componentized content may have more restrictive access controls, such as where universal control over components is centralized. Components may also be subject to different workflow and processes. Such workflow schemes or processes may require additional reviews and processing before allowing a component to be submitted or deployed.

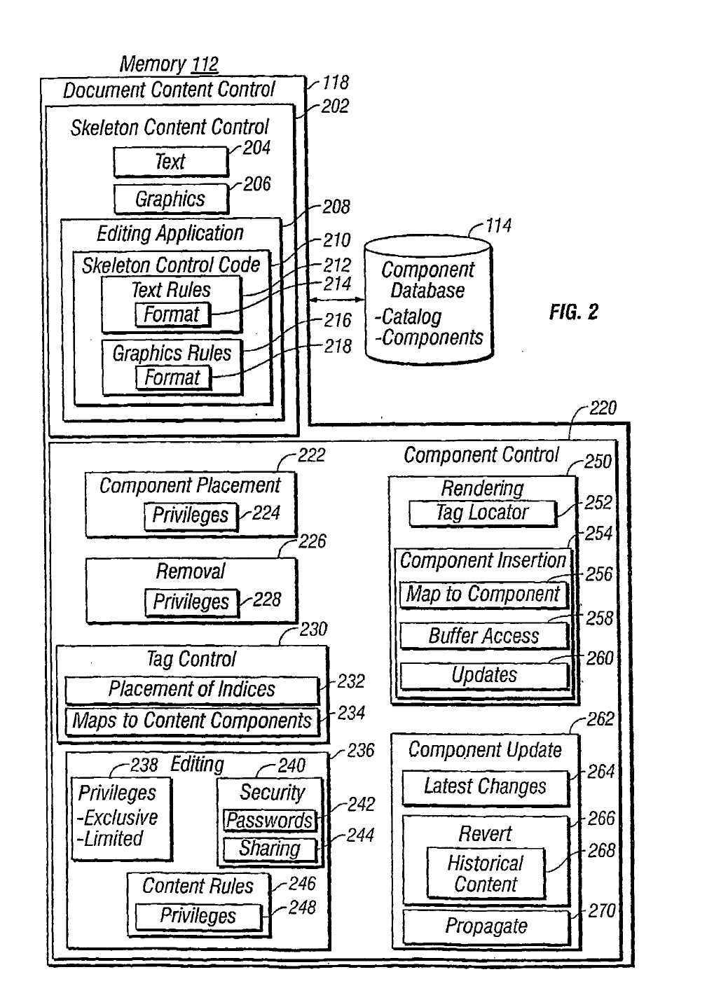

Referring to FIG. 2, a document content control application 118 stored in memory 112 (FIG. 1) is illustrated in more detail. The application 118 may also exist as a module in within a system, and may operate to augment a system that utilizes componentized content. In this description, there are various references to different types of code that define functions of the document content control application. Such code is essentially electronic software that defines and governs functions to be performed by a server when executed by a processor. The application includes skeleton content control code 202 configured to govern the development and maintenance of content that can be modified within a work area. Such skeleton content may include textual content 204 and graphics content 206. Editing application 208 is configured to control and enable the editing of content in a work area. The editing application may include skeleton control code 210 that is configured to control and enable the editing of skeleton content in a work area.

The skeleton content is synonymous with a skeleton document, which contains content, as well as references to components and subcomponents that may be stored in other locations. This skeleton is not meant to be limited to any particular content in a file or document, but is meant to refer to content that is not componentized. It some applications, users may have overlapping privileges to content that is contained in skeletons of documents as well as content that is contained in components. The invention is directed to the componentization of documents, where components are shared universally among a plurality of documents and files. The components are treated differently than skeletons, primarily because of their universal application.

The skeleton control code may include software code defining text rules 212 governing the editing of textual content. The text rules may include format code 214 for defining particular formats for textual content. Similarly, software code defining graphics rules 216 for controlling and enabling the editing of graphical content in a work area. The graphics rules may include graphics format code 218 for defining different graphical content formats.

Still referring to FIG. 2, the document content control application or module 118 includes component control module 220, configured with code that controls and enables the edition and use of components within documents. The component control code includes component placement code 222 for controlling and enabling the placement of components in a document. The placement code may include privileges code 224 that may place limits on certain placements of code within a document according to predetermined rules. Privileges may give different users or entities various privileges for defining the placement of components, and may define rules for sharing or otherwise defining such privileges. Similarly, component removal code 226 may be included for controlling and enabling the removal of components from a document or group of documents. The removal code may also include privileges code 228 that defines the manner in which different users or entities may remove content.

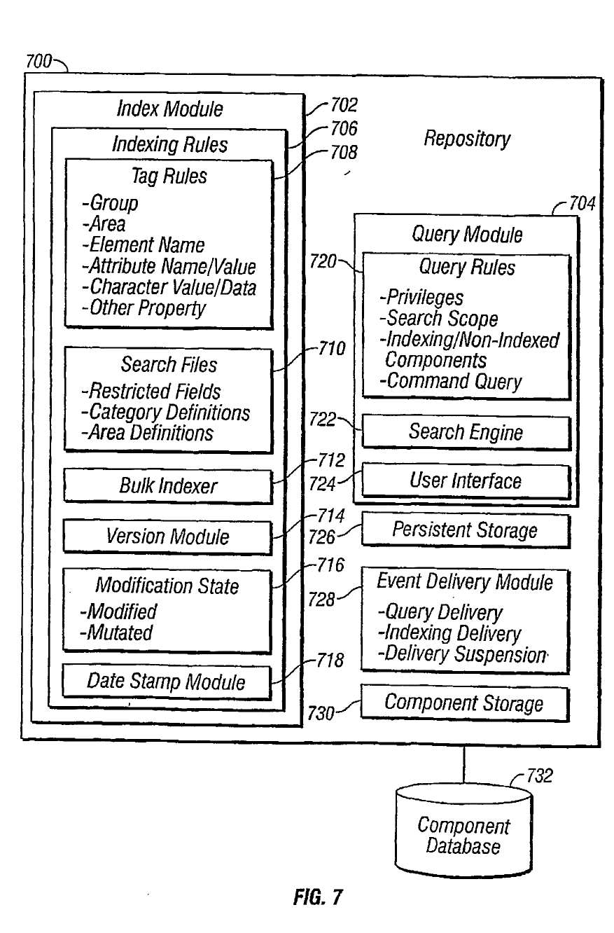

As discussed above, in one embodiment of the invention, tags may be placed in stored documents. These tags indicate which components can be rendered in a particular document and where it is located. Tag control code 230 is configured to control and enable the use of tags in documents for identifying and placing tags therein. The tag control code may include indicia placement code 232 configured to control and enable the placement of indicia, such as tags, in a document to indicate the use of a component. The code for mapping content to components 234 is configured to control and enable the mapping to memory locations to retrieve component content that is indicated by indicia within the document. A component may be defined in a system as simply content located at a memory address, where the address is accessible according to the component parameters, such as privileges to edit or otherwise modify the content, and other restrictions. According to the invention, these components are defined by the parameters of their mapping location as governed by the content mapping code. The locations of the components may vary depending on a particular application. In the embodiment illustrated in FIG. 2, components may be located in a database, where components are maintained and organized. Components may also be located in locations proximate the component control module, or in other locations convenient for their use, such as a repository, as illustrated in FIG. 7, and discussed in further detail below.

Editing code 236 is configured to control and enable the editing of components. Since components have unique properties, the invention provides special code to enable such properties. Privileges code 238 is provided for establishing privileges for access to components among users. The code may be configured to provide exclusive or limited access to components, allowing certain users to develop and modify components. Security code 240 is included to provide security protocols governing access to components. Security entities such as password protection code 242 and privilege sharing code 244 are included to provide users with the protection they need to guard their access privileges. Content rule code 246 is provided for controlling and enabling editing of components, including textual and graphical content that may exist in a component. Privileges code 248 may also be included for modifying or otherwise developing content rules.

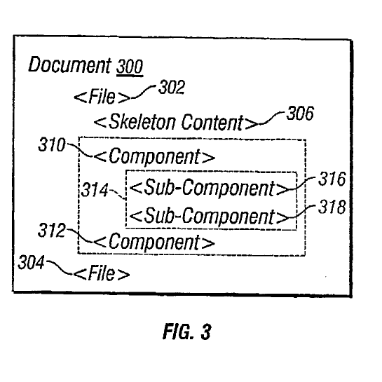

Referring to FIG. 3, a diagrammatical view of a sample document 300 having components according to the invention is illustrated. Skeleton content 306, which can appear anywhere in the document, is accessible by work areas and other authorized users. Component 310 includes sub-components 316, 318, and component 312 contains no sub-components. In operation, when components and sub-components are changed, the document is mutated, not necessarily modified. If the document is mutated, only its components are changed. The skeleton content is not changed. Therefore, the document does not need to be submitted to any staging or edition area. In contrast, if any of the skeleton content has been changed, in a work area for example, the document is deemed modified, and must necessarily be submitted to staging and edition areas.

Referring again to FIG. 2, rendering code 250 may be included to control and enable the rendering of a document with respect to components. As discussed above, those skilled in the art will understand that the general concept of rendering relates to composing something out of smaller parts. In the context of the invention, rendering relates to the process of replacing component references located within a document with component contents. In such a configuration, documents are configured to contain references to components that contain content that is shared with other documents that have the same references. According to the invention, rendering of a document can occur in various manners, and may also occur in disparate systems. For example, a work area may render a document by retrieving the file that corresponds to the document from a file system accessible by the work area. Upon receipt of the document, a user would pull up the document for observation on a monitor. In one embodiment of the invention, upon rendering a document, both skeleton content and the components are contained in the document and appear to the observer. The document may be configured so that the componentized content appears differently from the skeleton content. The components may be distinguished by appearing in italics or other font that is distinguishable from the other content. They may also appear as a different color or shade than other content to distinguish the componentized content from other content.

According to the invention, the state of the component can be ascertained upon rendering. Unlike conventional systems, the invention allows for a document to be rendered with current component content. If a component has been modified or mutated, it will contain indicia that indicates such a change. In some applications, components may have subcomponents, and ancestries of documents and components may run several layers deep. If a component has been modified or mutated within the ancestry chain, it could affect the layers of components that incorporate the component or document that has been modified or mutated. This way, documents and their children, such as components and subcomponents, can be updated accordingly, as well as automatically upon rendering.

Similarly, a website production server may render a document in serving a website. In such a rendering, the document would not likely distinguish componentized content from other content, as it is probably not provided for modifications. In some websites, interactive forms may be served to web browsers. In such applications, there exists content that may be modified by a web browser, but that is handled separately. The componentized content will still only be accessible to such a user on a read-only basis. It will be understood by those skilled in the art that different variations on implementation of the invention are possible in this regard without departing from the spirit and scope of the invention.

In one embodiment of the invention, a first implementation of placing a component, the components may be replaced with tags, indicia that identify components, including the current location of the component in memory and the location in which they appear on the document. This may be expressed as properties of the component, such as a category of the component and a unique identification code. Thus, the tags are holding places for components, and reside in the documents for use upon rendering. The rendering code includes tag locator code 252 configured to locate tags that may occur recursively throughout a document upon rendering of the document. Upon rendering, the components may be inserted into the document for observation by the user, such as in a work area, or an entity, such as a website production server.

In another embodiment, a second implementation of placing a component, in place of a component in a document, a void is left. To identify the component, all that is needed is 1) the offset of the component and 2) the length of the component. Upon rendering, the rendering code can be configured to pull in components from a location according to mapping coordinates.

For example, a program asks to read some data starting at offset 123 of a document. In the first implementation, the system would need to examine the entire document and replace all component references with actual component files, translate the encoding of the file into the proper encoding (see below regarding transcoding), then find offset 123 of the resulting data. It is useful to perform all of these steps once, then to buffer the resulting file for future access. In the second implementation, buffering is unnecessary. A map is retained that contains the offset, length and location of each component in the document. If the data at offset 123 is subsequently requested, the offset 123 can simply be looked up in the map to determine exactly which file contains that portion of the rendered document, and the data can be read directly. Building the map of component information takes about as much resources as rendering the document, but should take less storage space than the rendered document.

Component insertion code 254 is configured to control and enable the insertion of components into a document upon rendering. The insertion code may include code 256 configured to map to the location where the component is stored in memory so that it can be retrieved upon rendering. Buffer access code 258 is configured to enable the access to a buffer storing the latest version of a component. A buffer may be in the form of a buffered file, where components are stored and updated and where versions of components are stored. Updates code 260 may be configured to retrieve changes of components upon rendering according to timestamps of the components, and possibly timestamps of the tags that identify components to be pulled into the document.

Component update code 262 is configured to control and enable changes to components. According to the innovation, components are not handled the same as other content that can be modified in a document. And, as a result of their universal application to multiple documents, changes to components must necessarily have distinct protocols in order to properly update all documents that incorporate certain components. As discussed above, the latest changes 264 may be stored in memory as a buffer file. They may also be stored in various locations depending on a particular application. Changes to components and other content may occur on the development server by a user or entity having proper privileges. They may also occur on a client system 128, FIG. 1, by a user or entity having privileges at the client location. Wherever it is located, latest changes to components can be stored for efficient access.

According to the invention, it may also be useful in certain applications to retain different versions of components for access and retrieval. This allows for reversion to other component versions. Revert code 266 is configured to enable the reversion to older versions of content, and includes access to historical content via historical content code 268. Reversion to older components may be useful for limited promotions or sales offers for example, where one set of content defining the limited advertisement is universally broadcast to various documents defining webpages. This way, the content can be easily and efficiently released and retracted when needed. The historical data may be organized using timestamps, as those discussed above.

In changing components, it is important to update the documents that contain those components. In rendering documents, update code 260 may be configured to render components with the most recent content. However, if components are being used outside the work areas, for example in production servers that may be publicly viewed, special updating techniques are required. Propagate code 270 may be configured to propagate updates of components through documents that contain them. For example, if a component is updated, and a document defining a webpage is in production, it would be useful to direct the change to the webpage, even if none of the other content in the document has been updated, i.e., the document has been mutated. Propagate code may be configured to track which documents contain updated components, and to update them accordingly.

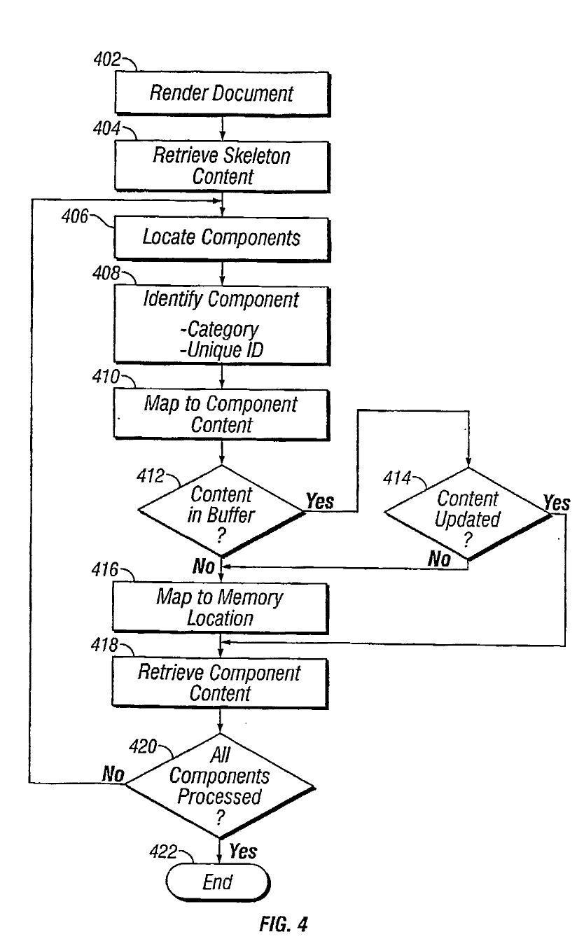

Referring to FIG. 4, a flow diagram illustrating the rendering operation 400 of one embodiment of the invention is illustrated. Rendering begins at step 402 where a request is asserted by a user or entity to render a document. Skeleton content is retrieved in step 404, which includes content that can be modified by a user or entity that may not be authorized to modify components, for example in a work area or production server. This step is followed by locating components in step 406 to be retrieved. This may entail locating tags that identify components, or offsets that locate components. Once found, components are identified in step 408, by category and unique ID for example, which the system uses to locate the components. In step 410, the component is located in its memory location by mapping to the location. The system may be configured to buffer versions of components. In one embodiment, tags that identify components are found by essentially scanning through the file data looking for the tags. If the data is XML, an XML parser may be used to break the XML data into a tree data structure in which individual nodes of the tree represent either XML data or one of the tags. The tree may then be traversed to find the special tag nodes. Then the tag nodes can be replaced with a tree representation of component which it refers to. Once all of the tag nodes have been replaced in this manner, a tree structure results that represents the entire rendered document. A standard algorithm can then be applied to convert the tree structure into a flat file.

A buffer is checked in step 412 to determine whether the desired component is located in the buffer. If so, then the buffer is checked to determine whether the desired content version is in the buffer in step 414. If not, then the process proceeds to step 416 to map to a memory location where the desired component version is located. Similarly, if, in step 412, it is determined that the desired component is not in the buffer, then the process goes to step 416 to map to the desired component version at its location in memory. In either case, once the desired version of the component is located, it is retrieved in step 418. The process then proceeds to step 420, where it is queried whether all components in the document have been located and processed. If not, the process returns to step 406 to further located components. If all components have been located and processed, the process ends at step 422.

Unlike the prior art, the invention allows the manipulation of components to be completely transparent to observers of documents containing components. The invention also allows for robust control during the updating and rendering processes so that components can be modified in order to accomplish certain goals. The invention allows for the flexibility to work with disparate systems, adapting component related operations to particular systems.

In some applications, components and other classes of content are transferred among disparate systems with different encoding protocols. For example, if a component were received from a first workstation at a development server under a first encoding, and was to be transferred to a second workstation that operates under a second incompatible encoding, a conflict would exist. It would be useful, therefore, to provide a means for translating such encoding so that it can be universally applied. As an optional aspect of the invention, a transcoder is provided to perform such encoding translations. In operation, a component may be received at one server and translated into a universal encoding. The component can then be operated on, modified, updated or otherwise changed, and stored. If transmission to another server is desired, the component can be translated to an encoding of the target server and deployed.

According to one embodiment of the invention, a component may also be transcoded automatically and independently from the encoding of each document that contains it. For example, suppose a component X is contained in documents A and B, and both A and B each has a different encoding. When Document A is rendered, the data that is contained in component X will appear in document A using document A's encoding. Meanwhile, if document B were rendered at the same time as document A, the data from component X would show up in document B using B's encoding. In effect, the data from component X can manifest itself in two different encodings simultaneously. Furthermore, the actual contents of component X itself do not need to be modified to accomplish this, only the rendered versions of the documents A and B contain the transcoded forms of component X. Therefore, disk space is not wasted on the various encodings of component X.

Referring to FIG. 5, and with reference to step 418 of FIG. 4, one example of an encoding scheme 500 according to the invention is illustrated. When the component content is retrieved from a location in Step 418, the encoding scheme of the target document is identified in step 502. This may be in the form of a tag in the skeleton of the document, or another predetermined identification configuration that identifies the encoding scheme of the document. Such identification techniques are well known in the art. Once identified, the component content is encoded according to the document's scheme in Step 504. Encoding techniques and schemes are well known in the art, and the invention is not limited to a particular encoding technique or scheme. Then, the encoded component content is incorporated in the target document in Step 506.

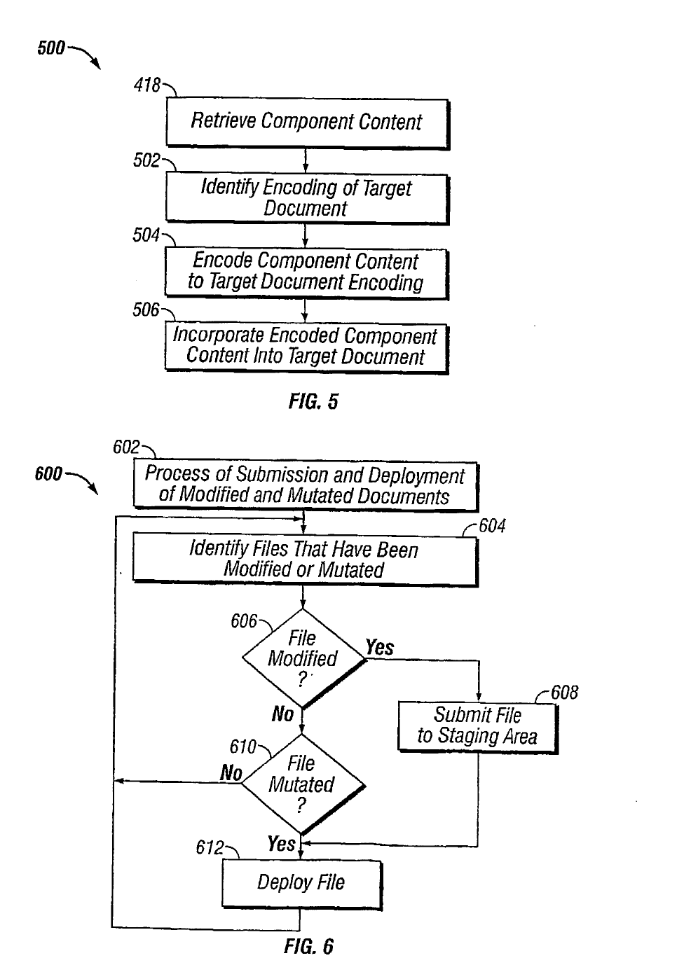

As discussed above, the process of submitting mutated and modified documents may receive separate treatment. Referring to FIG. 6, one such process, process 600, is illustrated. The process starts in step 602 where the deployment of a document initiated. In Step 604, the files that have been modified or mutated are identified. This may be accomplished by identification tags associated with the file, or other methods known in the art for identifying properties of documents or other objects. In Step 606, if the file was modified, the process proceeds to Step 608, where the file is submitted to the staging area. Such a file would be treated as any file that has been modified, whether it has components or not. If the file was not modified, the process proceeds to Step 610, where it is determined whether the file was mutated. If not, the process returns to step 604 to further identify files that have been modified or mutated. If a file was mutated, or after step 608, then the file is deployed in Step 612. Thus, according to the invention, files that have been modified are submitted to the staging area before they are deployed.

Once stored components are established, they can be indexed for search and retrieval. Components can be organized in a manner that would allow a user to compose new documents using the stored components. The indexing allows a user to easily search for componentized content, and can incorporate the content within a document skeleton. Referring to FIG. 7, an indexing and query repository 700 is illustrated. The repository may be implemented as part of a document content control module 118 (FIG. 1), and configured to control the indexing, searching, and other control over components, and may be implemented in a website development system. It could also be implemented as a more generic control module for controlling componentized contents for other entities as discussed above. The repository is a software application that is configured to manage and maintain the indexing and searching of components, as well as manage and maintain the components themselves.

The repository includes an index module 702 for managing indexing of components, and a query module 704 configured to manage searches for components stored in or by the repository. The index module includes indexing rules 706 that define the parameters within which indexing done. In one embodiment, components are stored and identified in a library like manner with identification tags. Different tagging techniques are well known by those skilled in the art, as are methods for tagging documents and files. The tag rules 708 define the different tags that can be used to identify components searched by the query module. The components can then be used in document skeletons according to the invention. In a website and maintenance application, the tag rules relate to components that are used in work areas and other areas where the componentization of contents are desired. Such tags include group tags that identify certain groups of contents, such as financial information for example.

Area tags designate components that were used in particular areas of the website maintenance system. Tags can also designate element names, attribute names and values, character values and data, and other properties that are relevant to components, and that would serve to be useful as search criteria. Search fields 710 can be defined for managing different fields searched out by the query module. Fields can be restricted and can be defined by category definitions as well as area definitions. Thus, fields can be limited to particular categories and work or staging areas, restricting particular users from these fields. Bulk indexer 710 can be configured to index components in bulk, where the components are related to each other in some way. Such an indexer can speed up the indexing process by processing large quantities of common components together.

Versioning module 714 is configured to govern the versions of components by indexing them accordingly. Since components may be modified or mutated according to the invention, they will necessarily have different versions when stored and indexed in the repository. The modification state 716 is an important identifier of these different versions, particularly when reusing components that are frequently modified. As discussed above, the modified or mutated components are treated differently than other components or documents, and may affect different system events, such as staging and deploying; One identifying tag that is particularly relevant to versions is a date stamp. The date stamp module 718 is configured to process date stamps of a component. Such a date stamp can take the form of a tag, and work in conjunction with the tag rules discussed above. When searching for components, users can utilize components best when they know the modification state and date stamp of the latest version of the component. If some have been modified or mutated and others have not, a user will can better choose components for a new document.

The query module 704 is configured to govern search activity, and includes query rules 720 to set parameters of such searches. The query rules include privileges code for restricting searching of particular components by certain users. The rules may also restrict or otherwise define search scope. As components may be restricted to particular users, it is logical that the component content may be restricted too, even if used for other purposes. Some components may be indexed, or, alternatively, may not be indexed for searching for various application reasons. The query module further includes a search engine 722, configured to search out components based on search criteria of a user, which may input the search criteria according to a user interface application 724. According to the invention, the searches are performed by searching for identification criteria of the index tabs associated with components, which are generated in the indexing module. Accordingly, components may be searched according to text strings that are contained in the components, as well as field strings located within the component. For example, a date field may be designated in a document, and components in general can be searched according to that particular date field. If the date field, such as a copyright date for example, is changed, all components containing that date field may be indexed and searched, and can also be modified for universal application. Such search engines are well known in the art.

The repository further includes persistent storage 726 for temporarily storing frequently accessed information. The event delivery module 728 is configured to deliver indexing and query events between the repository and the rest of the system. In a preferred embodiment, the delivery module is configured to render a document before it is indexed, allowing all fields and data to be indexed according to the index rules. Given the universal use of components and other content, there may exist redundant indexing as a result of such indexing techniques. However, the system may be configured to avoid such redundancy by identifying the components, and indexing them only once, such as at the component level. The delivery module utilizes the persistent storage for storing components and related data during processing. For example, in a query delivery, the delivery module could store search information in the persistent memory during processing. It could also aid in index delivery as well. The delivery module could temporarily store components that are transferred in bulk in the persistent memory, as well as components that are frequently changed in processing. The delivery module has a delivery suspension module configured to suspend delivery of an event. For example, an item may be incrementally indexed, where a single item needs to be updated many times in succession. Or, a large batch may need bulk re-indexing of an entire area, such as a work area, staging area, etc. In these circumstances, it is helpful to suspend the delivery event to accomplish these tasks.

Component storage 730 is configured to store components, indexed or not indexed, for searching and retrieval by a user. Components can alternatively be stored in a component database 732. As such, components may be stored in a database fashion for easy searching and retrieval.

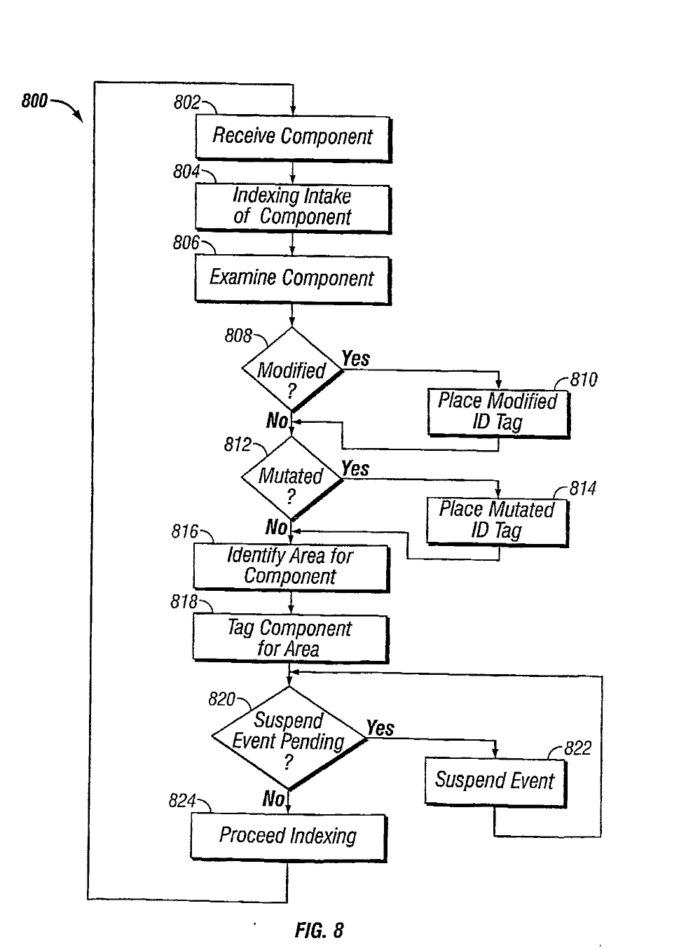

Referring to FIG. 8, an example of a component indexing method 800 according to the invention is illustrated. In step 802, the component is received, such as at the repository. The indexing module then performs the indexing intake of the component in Step 804. The properties of the component are then examined in Step 806, so that proper indexing identification can be performed. In Step 808, it is determined whether the component has been modified from a former version. If it has, a “Modified” identification tag is placed or associated with the component. Next, or if it is not modified from Step 808, the process proceeds to Step 812 where it is determined whether the component has been mutated. If so, a “Mutated” tag is placed or associated with the component in Step 814. Next, or if not mutated from Step 812, the process proceeds to Step 816 where the area of the component is determined, whether it is a work area, staging area, or other area. Then, the component is associated with a tag that indicates its area in Step 818. In step 820, it is determined whether a suspend event is indicated or pending. As discussed above, there may be circumstances where suspension of the deliver process, such as the delivery of components being indexed. If there is a suspending event pending, then the process proceeds to Step 822, where the process is suspended until the event is terminated. The process loops back to Step 820, where it is again queried whether a suspend event is still pending. Once it is no longer pending, indexing is proceeded in Step 824, and the process is routed back to Step 802 for further processing.

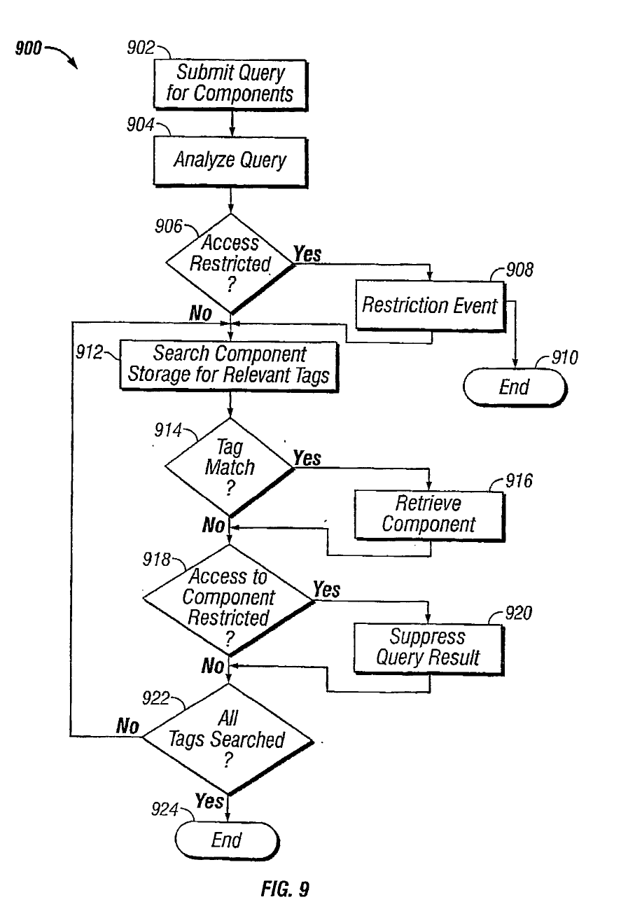

Referring to FIG. 9, an example of a search query method 900 configured according to the invention is illustrated. The process begins in Step 902, where a query is submitted for components. The query is then analyzed in Step 904. Optionally, it may be determined whether access is restricted in Step 906. If it is, then a restriction event is imposed in Step 908. Such a restriction event may cause the search to be restricted to particular components. If the user is restricted from performing a query at all, then the process may end at step 910. Steps 906-910 may be omitted, depending on the application. In another embodiment, the restriction steps may be superceded or replaced by tags on particular components that restrict their retrieval upon a query. Whether or not restricted, the process proceeds to Step 912, where the component storage is searched for components relevant to the query. This is done by the search engine reading their respective tags. If there is a tag match in Step 914, then the process retrieves the component in Step 916. Otherwise, and afterwards, the process proceeds to Step 918, where it is determined whether access to a component is restricted. This may be useful to restrict changes to particular components, where such changes may be sensitive, or have broad reaching ramifications. If there is a restriction, the system will suppress sending the result to the user of the query in step 920, and will in either case proceed to step 922, where it is determined whether all indexed tags have been searched. If not, the process proceeds back to Step 912, where the components are further searched. Otherwise, the process ends at Step 924.

In general, the invention may include the utilization of dedicated processors, webservers configured to receive and route browser requests, application servers, state servers and other types of computer processors configured to communicate amongst each other and that may be connected to one or more networks, including a Local Area Network (LAN), an intranet and the Internet. However, it will be appreciated by those skilled in the art, implementation of such devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although this embodiment is described and illustrated in the context of devices and systems for exchanging data among users of a computer system or network, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The apparatus and method include a method and apparatus for enabling and controlling componentized content within documents for storage in a document repository. This may be done in conjunction with the operation of a website development and maintenance software application. Although this embodiment is described and illustrated in the context of a software application for developing and maintaining Internet websites, the scope of the invention extends to other applications where maintenance and preservation of data at either a data source or destination is useful. Furthermore, while the foregoing description has been with reference to particular embodiments of the invention, it will be appreciated that these are only illustrative of the invention and that changes may be made to those embodiments without departing from the principles of the invention.

1. A method of dynamically composing a componentized electronic document comprising steps of:
(a) receiving a document containing an entity skeleton and tags that reference to components;
(b) locating component references in said entity skeleton;
(c) identifying one or more components according to component tags;
(d) determining a component which has a changed state;
(e) based on said changed state, mapping to a component content corresponding to said determined component;
(f) retrieving said corresponding component content from a memory location; and
(g) incorporating said retrieved component content into said document.

2. The method according to claim 1, wherein step (c) comprises the step of:
identifying a component by analyzing a component tag according to a category and a unique identification indicator.

3. The method according to claim 1, wherein step (e) comprises the steps of:
checking whether said corresponding component content is located in a buffer;
if said corresponding component content is not located in a buffer, continuing on step (f);
if said corresponding content is located in a buffer, determining whether said corresponding component content has been updated:
if said corresponding content is updated, then retrieving said updated component content from said buffer and continuing on step (g); and
if said corresponding component content is not updated, then continuing on step (f).

4. The method according to claim 1, wherein said entity is configured in an XML format containing text and graphical data.

5. The method according to claim 1, wherein said components are shared with other entities to provide universal Consistence among documents that incorporate said components.

6. The method according to claim 1, wherein said entity skeleton Is configured to contain references to components in predetermined locations within said entity skeleton.

7. The method according to claim 1, wherein said entity skeleton includes non-componentized content within said entity skeleton.

8. A system configured to manage content componentization of electronic documents that share common content, each of said documents having an entity skeleton comprising componentized content and tags that identify said componentized content, said system comprising:
a content control module configured to manage content;
an editing application configured to manage content editing;
a component control module configured to manage components and to track changes in states of said components, wherein each of said components has its corresponding content;
a repository configured to manage indexing, searching and retrieving of said components; and
a component storage configured to store indexed components;
wherein when a component is updated, each and every of said documents that reference said updated component is automatically updated upon rendering.

9. The system according to claim 8, wherein said repository comprises an index module configured to manage component indexing and a query module configured to manage component searching.

10. The system according to claim 8, further comprising a version module configured to indicate state Information and version information of a component.

11. The system according to claim 8, further comprising a development server configured to develop documents having website content, said development server being communicatively connected to a global network which can be accessed by users.

12. The system according to claim 8, wherein said Index module manages component indexing according to tags associated with individual components, and wherein said query module manages component searching by setting parameters according to one or more query rules.
